(19) United States
(12) Patent Application Publication
(10) Pub. No.: US 2019/0172288 A1
(43) Pub. Date: Jun. 6, 2019

(54) METHOD AND APPARATUS FOR A SHIPMENT STORAGE APPARATUS

(71) Applicants: Mareike Tietz, Koln (DE); Christian Kasper, Bruhl (DE); Sven Frankemölle, Bonn (DE)

(72) Inventors: Mareike Tietz, Koln (DE); Christian Kasper, Bruhl (DE); Sven Frankemölle, Bonn (DE)

(73) Assignee: Deutsche Post AG, Bonn (DE)

(21) Appl. No.: 16/209,693

(22) Filed: Dec. 4, 2018

(30) Foreign Application Priority Data
Dec. 4, 2017 (DE) 10 2017 128 775.2

(51) Int. Cl. G07C 9/00; G06Q 50/28; G08B 13/08

(52) U.S. Cl. CPC G07C 9/00309; G07C 2009/0092; G08B 13/08; G06Q 50/28

(57) ABSTRACT

A method for a shipment storage apparatus is disclosed. The shipment storage apparatus includes a storage space having a plurality of shipment retainers arranged in it. In the method, access authorization information is obtained. The access authorization information authorises a user to access one or more of the shipment retainers. It is determined whether access by the user to one or more of the shipment retainers can be granted, at least in part on the basis of the obtained access authorization information. Only if it has been determined that access by the user to one or more of the shipment retainers can be granted, access of the user to the storage space is granted, and it is determined whether the user accesses only the one or more of the shipment retainers that the access authorization information authorises the user to access.

### CROSS REFERENCE TO RELATED PATENT APPLICATION

This patent application claims priority to German Application No. 10 2017 128 775.2, filed Dec. 4, 2017, the entire teachings and disclosure of which are incorporated herein by reference thereto.

### FIELD

Exemplary embodiments of the invention relate to a method for a shipment storage apparatus.

### BACKGROUND

The number of parcel deliveries is rising continuously, e.g. on account of rising Internet and mail-order orders. Multiple delivery attempts are then frequently necessary on account of the absence of the respective recipient. Overall, the performance of parcel deliveries is thus highly personnel-intensive and time-consuming today.

### Summary of a Few Exemplary Embodiments of the Invention

The present invention is thus based, inter alia, on the object of overcoming these problems and, inter alia, providing an opportunity for a more efficient way of performing parcel deliveries, for example in the form of the method for a shipment storage apparatus that is disclosed below.

According to the invention, a method for a shipment storage apparatus is disclosed, wherein the shipment storage apparatus comprises a storage space, wherein the storage space has a plurality of shipment retainers arranged in it and wherein the method comprises:
obtaining access authorization information, wherein the access authorization information authorises a user to access one or more of the shipment retainers,
determining whether access by the user to one or more of the shipment retainers can be granted, at least in part on the basis of the obtained access authorization information,
only if it has been determined that access by the user to one or more of the shipment retainers can be granted:
granting or causing the granting of access of the user to the storage space and
determining or causing the determining of whether the user accesses only the one or more of the shipment retainers that the access 5 authorization information authorises the user to access.

For example, the disclosed method is performed at least in part by a control apparatus and/or by respective means of the control apparatus, for example the control apparatus disclosed below.

According to the invention, a control apparatus is further disclosed, wherein the control apparatus comprises means configured for performing the method according to the invention or respective means for performing the steps of the method according to the invention.

In this case, different steps can optionally be performed by different means.

The means of the control apparatus according to the invention can comprise hardware and/or software components.

By way of example, the means can comprise at least one memory having program instructions of a computer program (e.g. the computer program according to the invention) and at least one processor designed for executing program instructions from the at least one memory. Accordingly, the invention is also intended to be understood as disclosing a control apparatus that comprises at least one processor and at least one memory having program instructions, wherein the at least one memory and the program instructions are configured so as, together with the at least one processor, to cause the control apparatus to perform the method according to the invention.

Alternatively or additionally, the means can further comprise one or more communication interfaces (e.g. one or more wireless and/or wired network adapters) and/or one or more user interfaces.

For example, the control apparatus is a server (e.g. a back end server such as a back end server of a delivery service). It goes without saying that a server of this kind may be either a physical server (i.e. a server having hardware and/or software components) or a virtual server. In this context, a virtual server is intended to be understood to mean, by way of example, a virtual machine provided by hardware and/or software components of one or more physical servers (e.g. multiple servers in what is known as a server cloud).

A user interface is, by way of example, a keyboard, a mouse, a camera, a screen, a touch sensitive screen, a loudspeaker, a microphone and/or a biometric sensor such as a fingerprint sensor and/or an iris scanner. A user interface is, by way of example, configured for capturing information in the form of a user input (e.g. as a keyboard or mouse input and/or as a voice input and/or as a gesture) and/or an input of a biometric feature (e.g. a fingerprint and/or an iris image) and/or for outputting information in the form of a, by way of example, audible and/or visual user output (e.g. as a voice output and/or as a text output).

A communication interface is, by way of example, configured for sending and/or receiving information. A communication interface may be, by way of example, a wireless and/or wired communication interface. A wireless communication interface is, by way of example, configured for sending and/or receiving information using a wireless communication technique, and a wired communication interface is, by way of example, configured for sending and/or receiving information using a wired communication technique.

An example of a wireless communication technique is a local radio network technique such as radio frequency identification (RFID) and/or near field communication (NFC) and/or Bluetooth (e.g. Bluetooth version 2.1 and/or 4.0) and/or Wireless Local Area Network (WLAN). RFID and NFC are specified according to ISO standards 18000, 11784/11785 and ISO/IEC standards 14443-A and 15693, for example. The Bluetooth specifications are currently available on the Internet at www.bluetooth.org. WLAN is specified in the standards of the IEEE 802.11 family, for example. A further example of a wireless communication technique is a nationwide radio network technique such as, for example, a low power wide area network (LPWAN) and/or a mobile radio technique, for example Global System for Mobile communications (GSM) and/or Universal Mobile Telecommunications System (UMTS) and/or Long Term Evolution (LTE). The GSM, UMTS and LTE specifications are maintained and developed by the 3rd Generation Partnership Project (3GPP) and are currently available on the Internet at www[dot]3gpp[dot]com. An example of an LPWAN specification is the LoRa standard developed and maintained by the LoRa Alliance (www[dot]lora-alliance[dot]org) or the SIGFOX radio network technology developed by the SIGFOX company.

An example of a wired communication technique is a local network technique such as Ethernet and/or Universal Serial Bus (USB, e.g. USB version 2.0 and/or 3.0). Ethernet is specified in the standards of the IEEE 802.3 family, for example. The USB specifications are currently available on the Internet at www[dot]usb[dot]org, inter alia. A further example of a wired communication technique is nationwide transmission standards such as Integrated Services Digital Network (ISDN) and/or Digital Subscriber Line (DSL). The DSL specifications have been specified at least in part by the ITU-T (e.g. ADSL, ADSL+, VDSL1 and VDSL2) and are currently available on the Internet at www[dot]itu[dot]int, inter alia. ISDN has likewise been specified by the ITU-T.

It goes without saying that the control apparatus can also comprise other means not listed.

The control apparatus according to the invention is, by way of example, a control apparatus for a shipment storage apparatus, for example a control apparatus for at least in part controlling the shipment storage apparatus.

According to the invention, a system is further disclosed, wherein the system comprises:
a shipment storage apparatus, wherein the shipment storage apparatus comprises a storage space, and wherein the storage space has a plurality of shipment retainers arranged in it, and
the disclosed control apparatus.

According to the invention, a computer program is further disclosed, wherein the computer program comprises program instructions designed so as, when executed by at least one processor, to cause an apparatus (e.g. the disclosed control apparatus) to perform the disclosed method.

The disclosed computer program is contained and/or stored on a computer-readable storage medium, for example. A computer-readable storage medium is intended to be understood to mean a physical and/or tangible storage medium, for example.

The text below describes the features of the disclosed method, the disclosed control apparatus, the disclosed system and the disclosed computer program—sometimes by way of example.

A shipment can be understood to mean a packaged item, a piece good, a parcel shipment (e.g. a parcel) and/or a mail shipment (e.g. a letter), for example. It goes without saying that a shipment can comprise or may be formed by a liquid, a gas or a loose good.

A shipment storage apparatus is an apparatus for storing one or more shipments. By way of example, one or more shipments can be deposited in a shipment storage apparatus of this kind (e.g. in one or more shipment retainers arranged therein) by a delivery agent and stored therein until they are collected by the recipient of the shipments. Further, one or more shipments can also be deposited in a shipment storage apparatus of this kind (e.g. in one or more shipment retainers arranged therein) by a sender of the shipments for collection by a delivery agent. Both the delivery agent and the recipient or the sender are users of the shipment storage apparatus in these examples. A delivery agent is an employee of a delivery service such as a postman/postwoman, parcel courier, postal courier or letter-carrier, for example. In this case, a delivery service is intended to be understood to mean, by way of example, a delivery company such as a postal and/or logistics company that transports and delivers shipments. For example, the shipment storage apparatus is made available (e.g. by a user of the shipment storage apparatus) to a delivery service for storing one or more shipments in the course of the delivery and transport of shipments. It goes without saying that the shipment storage apparatus may alternatively also be a shipment storage apparatus of the delivery service.

A shipment storage apparatus is intended to be understood to mean an apparatus that comprises a storage space. In this case, the storage space is a space and/or area at least in part surrounded by the apparatus, for example. For example, the storage space is not freely accessible. By way of example, the storage space is accessible at least (e.g. only) by means of a closure means (e.g. a door and/or shutter) for closing an opening of the shipment storage apparatus.

An example of a shipment storage apparatus is a building and/or part of a building, such as, by way of example, a garage or a garden building or a tool shed (e.g. the building and/or the part of the building is made available to a delivery service by the owner of the building for storing one or more shipments in the course of the delivery and transport of shipments). The storage space may accordingly be part of this building. For example, the storage space is a room of this building and/or a space inside this building (e.g. a space enclosed by the building). The space is accessible only by means of a door of the building, for example. It goes without saying that the invention is not restricted to this example. Further examples of a shipment storage apparatus are a fenced-off outside area, wherein the fenced-off area is accessible by means of a door and is intended to be understood to mean a storage space, or a storage box, wherein the interior of the storage box is accessible by means of a shutter and is intended to be understood to mean a storage space.

Preferably, the shipment storage apparatus is unsupervised. The fact that the shipment storage apparatus is unsupervised is intended to be understood to mean, by way of example, that the shipment storage apparatus is at least not constantly guarded (i.e. guarded by one or more persons, e.g. a user) in order to prevent unauthorised access to the shipments stored therein (e.g. the shipment retainers and shipments retained thereby).

A shipment retainer is an apparatus for retaining a shipment, for example. In this case, a shipment is intended to be understood as retained, inter alia, if it (i) is on the shipment retainer and is supported by the shipment retainer, (ii) is at least in part held by the shipment retainer and/or (iii) is connected to the shipment retainer with a force fit (e.g. in the form of a clamp connection). A shipment retainer of this kind for retaining a shipment may at least in part be in the form of a clamping apparatus, a holding apparatus (e.g. in the form of a holding box and/or a holding compartment) and/or a rack apparatus (e.g. in the form of a shelf and/or shelf compartment). It goes without saying that the invention is not restricted to these examples and the shipment retainer can also be in another form.

A plurality of shipment retainers is intended to be understood to mean multiple shipment retainers (i.e. at least two shipment retainers). Accordingly, the storage space of the shipment storage apparatus has at least two shipment retainers arranged in it.

A shipment retainer is intended to be understood, by way of example, as arranged in the storage space when the shipment retainer is in the storage space. For example, a shipment retainer is intended to be understood as arranged in the storage space when the shipment retainer is mounted in the storage space. If the shipment storage apparatus is a building and/or part of a building, a shipment retainer may be arranged, by way of example, in the storage space by virtue of the shipment retainer being mounted on a wall enclosing the storage space. Such mounting is preferably permanent mounting (i.e. mounting that is not detachable nondestructively) such as an adhesive bond, a welded joint, a threaded insert joint and/or a rivet joint. This accordingly also applies to other means and/or apparatuses arranged in the storage space (e.g. one or more sensors and/or signal transmitters arranged in the storage space).

The access authorization information can be obtained, by way of example, together with access request information that is used to request access to the storage space of the shipment storage apparatus.

The access authorization information (e.g. together with the access request information) can be obtained by capturing a user input, for example. A user input of this kind can be provided by means of a user interface of the control apparatus and/or a user interface connected to the control apparatus, for example. Further, the access authorization information (e.g. together with the access request information) can also be received and, as a result, obtained. For example, the access authorization information can be received by a communication interface of the control apparatus. It goes without saying that a part of the access authorization information can also be obtained by means of the capture of a user input and a further part of the access authorization information can be obtained by means of the reception. For example, there may be provision for a code and/or a password and/or a personal identification number (PIN) and/or a biometric feature (e.g. in the form of a fingerprint and/or an iris image) of a user to be captured as a user input and for further information to be received from a user apparatus (e.g. a portable user apparatus) of the user, for example. This is advantageous in order to allow 2-factor authentication, for example.

The user authorised by the access authorization information is, by way of example, a user of the shipment storage apparatus such as a delivery agent and/or a recipient and/or a sender of a shipment. The access authorization information contains and/or represents one or more access authorization parameters, for example. The access authorization parameters are used for verifying and/or defining the authorization of the user to access one or more of the shipment retainers, for example. Examples of such access authorization parameters are: (i) an (in particular explicit) identifier for the shipment storage apparatus, (ii) an (in particular explicit) identifier for one or more shipment retainers of the shipment retainers and/or one or more shipments retained thereby, (iii) an (in particular explicit) identifier for the access authorization information itself, validity period information (e.g. in the form of a “Not Before Date”, a “Not After Date”, a “Start Time for the Day” and an “End Time for the Day”, which indicate within which days and within which time of day the user is authorised for access, for example from 27.3.2018 00:00:00 hours to 28.3.2018 23:59:59 hours), (iv) an (in particular explicit) identifier for the user (e.g. in the form of a user number and/or a user name and/or a code and/or password and/or PIN), (v) an upper limit for the permitted uses of the access authorization information in order to gain access (e.g. only once), (vi) information regarding the extent to which the user is authorised for access (that is to say, by way of example, whether the user is authorised for access to all shipment retainers or just to one or more of the shipment retainers) and (vii) a digital signature for verifying the trustworthy origin of the access authorization information and the integrity of the access authorization information. It goes without saying that the invention is not restricted to these examples, and the access authorization information can also contain and/or represent other and/or any combination of these access authorization parameters.

Determining whether access by the user to one or more of the shipment retainers can be granted, at least in part on the basis of the obtained access authorization information, is intended to be understood to mean, by way of example, that a check is performed to determine whether the obtained access authorization information authorises a user (e.g. the user whose identifier is represented by or contained in the access authorization information) to access one or more of the shipment retainers. The check can be performed at least in part on the basis of a shipment storage and/or user database, for example. The shipment storage and/or user database is stored in a memory of the control apparatus, for example. Alternatively, there may also be provision for the shipment storage and/or user database to be stored in a memory separately from the control apparatus. For example, the shipment storage and/or user database contains and/or represents check information such as shipment storage and/or user information for checking whether the obtained access authorization information authorises a user (e.g. the user whose identifier is represented by or contained in the access authorization information) to access one or more of the shipment retainers (e.g. in the form of a shipment storage and/or user database entry that links information represented by and/or contained in the access authorization information to the identifier of one of the shipment retainers). It goes without saying that the check can also be performed at least in part independently of a shipment storage and/or user database of this kind.

The granting of access for the user to the storage space can be effected, by way of example, by unlocking and/or opening a closure means (e.g. a door and/or shutter) for closing an opening of the shipment storage apparatus. Causing the granting of the access of the user to the storage space is intended to be understood to mean, by way of example, that the granting of the access is controlled, for example by virtue of the closure means (e.g. a door and/or shutter) for closing an opening of the shipment storage apparatus being actuated such that it unlocks and/or opens. The closure means (e.g. a door and/or shutter) has an actuatable unlocking means (e.g. an actuatable unlocking mechanism such as an electronic lock) for unlocking the closure means and/or an actuatable opening means (e.g. an actuatable opening mechanism such as a door opener and/or door buzzer) for opening the closure means, for example. Actuation of this kind is intended to be understood to mean, by way of example, that control information is sent (e.g. by a communication interface of the control apparatus) to the closure means (e.g. to an unlocking means and/or an opening means of the closure means, e.g. via a communication interface of the closure means) that is configured to cause the closure means (e.g. an unlocking means and/or an opening means of the closure means) to unlock and/or open.

The determining of whether the user accesses only the one or more of the shipment retainers that the access authorization information authorises the user to access comprises, by way of example, the monitoring of whether the user accesses one or more of the shipment retainers that the access authorization information does not authorise the user to access. This can be effected at least in part on the basis of sensor information, for example, as disclosed in detail below.

The causing of the determining of whether the user accesses only the one or more of the shipment retainers that the access authorization information authorises the user to access is intended to be understood to mean, by way of example, that the shipment retainers are caused to monitor whether the user accesses one or more of the shipment retainers that the access authorization information does not authorise the user to access. For example, at least each of the shipment retainers that the access authorization information does not authorise the user to access is sent control information configured to cause the shipment retainer to monitor whether the user accesses it. Alternatively, there may also be provision for each of the shipment retainers to continuously monitor whether a user accesses it. In this case, by way of example, each of the shipment retainers that the access authorization information authorizes the user to access can be sent control information configured to cause the respective shipment retainer to interrupt the monitoring (e.g. until the user has deposited or taken a shipment in or from the respective shipment retainer).

This is advantageous, by way of example, in order to monitor shipments deposited for collection in a storage space of a shipment storage apparatus and therefore to ensure due collection (e.g. via the recipient) of such a shipment or to be able to detect and preferably prevent unauthorised access to such a shipment. This allows safe delivery of a shipment without the recipient of the respective shipment needing to be present, which means that the presence of the recipient makes no difference for the delivery and therefore the number of delivery attempts can be reduced and the efficiency of the delivery can be increased.

Further advantages of the disclosed invention are described below on the basis of exemplary embodiments of the disclosed method, the disclosed control apparatus, the disclosed system and the disclosed computer program.

In an exemplary embodiment of the invention, the access authorization information is received from a portable user apparatus.

As disclosed above, the access authorization information can be received and, as a result, obtained. For example, the access authorization information can be received by a communication interface of the control apparatus.

For example, the access authorization information can be received from a portable user apparatus of a user of the shipment storage apparatus. Such a user of the shipment storage apparatus is, as disclosed above, a delivery agent and/or a recipient and/or a sender of a shipment, for example. The access authorization information can authorise the user of the user apparatus to access one or more of the shipment retainers, for example.

Examples of a portable user apparatus are a mobile phone (e.g. a smartphone), a wearable computer (e.g. a smartwatch or a smartband), a tablet computer, a personal digital assistant (PDA), a portable media player, a portable navigation device or a “tag” (e.g. an RFID or NFC tag such as a “tag” from the MiFARE family from NXP). Further, a portable user apparatus may also be, by way of example, a delivery agent device of a delivery agent such as a hand-held scanner (e.g. the Honeywell LXE Tecton MX7).

In an exemplary embodiment of the invention, the access authorization information is at least one of the following pieces of access authorization information:
access authorization information for collecting of at least one shipment,
access authorization information for depositing of at least one shipment.

It goes without saying that the access authorization information may also be access authorization information for collecting of multiple shipments and/or access authorization information for depositing of multiple shipments. The text below describes this embodiment for the collection and/or depositing of a single shipment by way of example merely for reasons of better reconstructibility. This disclosure is accordingly also intended to apply to the collection and/or depositing of multiple shipments, however. Access authorization information for collecting of a shipment authorises the user only to access the shipment retainer that retains this shipment, for example.

For example, such access authorization information for collecting of a shipment contains and/or represents an (in particular explicit) identifier for the shipment. When determining whether access by the user to one or more of the shipment retainers can be granted, a check is accordingly performed to determine whether one of the shipment retainers arranged in the storage space retains a shipment having this (in particular explicit) identifier, for example. If the result of the check is that one of the shipment retainers arranged in the storage space does retain a shipment having this (in particular explicit) identifier, it is possible to determine that access by the user to the shipment retainer that retains the shipment having this (in particular explicit) identifier can be granted, for example.

It goes without saying that the access authorization information can, by way of example, alternatively or additionally also contain or represent an (in particular explicit) identifier for the shipment retainer that retains the shipment, which means that when determining whether access by the user to one or more of the shipment retainers can be granted a check is performed to determine whether one of the shipment retainers arranged in the storage space is a shipment retainer having this (in particular explicit) identifier, for example. If the result of the check is that one of the shipment retainers arranged in the storage space is the shipment retainer having this (in particular explicit) identifier, it is possible to determine that access by the user to the shipment retainer having this (in particular explicit) identifier can be granted, for example.

Access authorization information for depositing of a shipment authorises the user (in contrast to access authorization information for collecting of a shipment) only to access at least one free shipment retainer of the shipment retainers, for example.

For example, such access authorization information for depositing of a shipment contains and/or represents an (in particular explicit) identifier for at least one free shipment retainer of the shipment retainers. When determining whether access by the user to one or more of the shipment retainers can be granted, a check is accordingly performed to determine whether one of the shipment retainers arranged in the storage space is a shipment retainer having this (in particular explicit) identifier, for example. In this example, it is possible to determine that access by the user to the shipment retainer having this (in particular explicit) identifier can be granted if the result of the check is that one of the shipment retainers arranged in the storage space is the shipment retainer having this (in particular explicit) identifier, for example.

It goes without saying that the access authorization information can alternatively or additionally also contain information indicating that the user is authorised only to access at least one free shipment retainer of the shipment retainers, which means that when determining whether access by the user to one or more of the shipment retainers can be granted a check is performed to determine whether at least one of the shipment retainers arranged in the storage space is free (i.e. is not retaining a shipment), for example. If the result of the check is that at least one of the shipment retainers arranged in the storage space is free, it is possible to determine that access by the user to the at least one free shipment retainer can be granted, for example.

As disclosed above, the check can be performed at least in part on the basis of a shipment storage database, for example. In this case, the shipment storage database or a part of the shipment storage database may be stored locally (e.g. in a memory of the control apparatus), for example. Alternatively or additionally, there may also be provision for the shipment storage database or a part of the shipment storage database to be stored separately (e.g. in a memory separately from the control apparatus). For example, the shipment storage database contains and/or represents shipment storage information for checking whether a shipment having an (in particular explicit) identifier is retained by one shipment retainer of the shipment retainers (e.g. in the form of a shipment storage database entry linking the identifier of the shipment to the identifier of one of the shipment retainers) and/or whether a shipment retainer having an (in particular explicit) identifier is arranged in the storage space of the shipment storage apparatus (e.g. in the form of a shipment storage database entry linking the identifier of the shipment retainer to the identifier of the shipment storage apparatus) and/or whether at least one of the shipment retainers arranged in the storage space is free (e.g. in the form of one or more shipment storage database entries representing and/or containing the identifier(s) of the free shipment retainer(s)).

Access authorization information for collecting of at least one shipment and/or for depositing of at least one shipment can be used by recipients and/or senders of shipments, for example. For example, a recipient of a shipment receives a notification with access authorization information for collecting of the shipment when the shipment has been deposited in a shipment retainer of the shipment storage apparatus; and a sender of a shipment can request a notification with access authorization information for depositing of the shipment in a shipment retainer of the shipment storage apparatus, for example. This restricts the access by the recipients and/or senders of shipments to one or more specific collections and/or deposits. It goes without saying that applicable access authorization information for collecting of at least one shipment and/or for depositing of at least one shipment can also be used for a delivery agent. However, there may also be provision for the delivery agent to be fundamentally permitted to access all shipment retainers of the shipment storage apparatus in order to allow the delivery agent the most flexible depositing and collection of shipments possible.

In an exemplary embodiment of the invention, the shipment storage apparatus is a building and/or part of a building, and wherein the storage space is a room of the building. As disclosed above, the building is a garage or a garden building or a tool shed, for example. The storage space may accordingly be part of this building. For example, the storage space is a room of this building and/or a space inside this building (e.g. a space enclosed by the building). The space is accessible by means of a door of the building, for example.

In an exemplary embodiment of the invention, the access for the user to the storage space is granted by unlocking and/or opening a door of the shipment storage apparatus. If the shipment storage apparatus, as disclosed above, is a building and/or part of a building, then the door is a door of this building, for example.

As disclosed above, the door can have an actuatable unlocking means (e.g. an actuatable unlocking mechanism such as an electronic lock) for unlocking the door and/or an actuatable opening means (e.g. an actuatable opening mechanism such as a door opener and/or door buzzer) for opening the door, for example. Accordingly, the causing of the granting of the access to the storage space can be effected by means of the applicable actuation of the unlocking means, in order to cause the door to be unlocked, and/or of the opening means, in order to cause the door to be opened.

In an exemplary embodiment of the invention, the determining of whether the user accesses only one or more of the shipment retainers that the access authorization information authorises the user to access is based at least in part on sensor information.

Sensor information represents a parameter captured by a sensor 5 at the position of the sensor, for example (e.g. a measured value for a physical or chemical variable capturable at the position of the sensor). The sensor information represents parameters captured by one or more different sensors (e.g. by at least two different sensors), for example.

For example, the sensor information can be obtained at least in part by means of the capture of one or more parameters by one or more sensors (e.g. if the sensors are, at least in part, part of the control apparatus). Alternatively or additionally, the obtaining of the sensor information at least in part can also be effected by means of the reception of the sensor information (e.g. by a communication interface of the control apparatus) (e.g. if the sensors are, at least in part, external to the control apparatus).

For example, the sensor information represents one or more parameters, wherein the parameters are captured by one or more sensors arranged in the storage space and/or by one or more sensors of the shipment retainers.

By way of example, each of the shipment retainers comprises at least one sensor, wherein the respective sensor is configured to capture at least one of the following shipment retainer parameters:
a weight of a shipment retained by the respective shipment retainer,
a vibration in the respective shipment retainer,
opening and/or closing of a closure means of the respective shipment retainer,
damage to the respective shipment retainer and/or to a part of the respective shipment retainer,
a tag on a shipment retained by the respective shipment retainer.

Examples of sensors for capturing these shipment retainer parameters are a pressure sensor for detecting a weight (e.g. a piezo resistive or capacitive pressure sensor), a radio sensor for detecting an (e.g. wirelessly detectable) tag (e.g. a wireless communication interface such as an RFID, NFC and/or Bluetooth sensor), an image sensor for detecting an (e.g. optically detectable) tag (e.g. a still-image and/or video camera, a CMOS sensor and/or a CCD sensor), an opening and/or closing sensor for detecting opening and/or closing of a closure means, a sensor for detecting a vibration (e.g. an acceleration sensor) or a sensor for detecting damage (e.g. a capacitive sensor and/or an acceleration sensor). It goes without saying that this list is merely exemplary and not conclusive.

If the weight of a shipment retained by the respective shipment retainer changes, then it can be inferred that the shipment retained by the respective shipment retainer has changed, e.g. because a shipment has been deposited in the respective shipment retainer or a shipment has been taken from the respective shipment retainer. A similar inference can also be made if closure means of the respective shipment retainer open and/or close or a tag on a shipment retained by the respective shipment retainer changes. Damage to the respective shipment retainer and/or to a part of the respective shipment retainer and a vibration in the respective shipment retainer suggest that access to the respective shipment retainer is taking place (e.g. unauthorised access in the event of damage).

A change to one or more of these shipment retainer parameters therefore suggests possible access to the respective shipment retainer. The capture of these shipment retainer parameters is therefore advantageous in order to be able to determine whether possible access to one or more of the shipment retainers is taking place. For example, it may be stipulated that if a change to a shipment retainer parameter is detected by a sensor of a respective shipment retainer, it is determined that access to this respective shipment retainer is taking place. If the access authorization information does not authorise the user to access this respective shipment retainer, it is further determined that the user is unauthorisedly accessing this respective shipment retainer, for example. Further, it may be stipulated, by way of example, that if damage to the respective shipment retainer and/or to a part of the respective shipment retainer is detected by a sensor of a respective shipment retainer, it is determined that the user is unauthorisedly accessing this respective shipment retainer. It goes without saying that if the sensor information suggests possible access and this is subsequently determined accordingly based on the sensor information, access does not necessarily also actually need to be taking place (e.g. because a sensor is faulty or another event has led to the sensor information).

Further, the storage space may have one or more sensors arranged in it, wherein the sensors are configured to capture at least one of the following storage space parameters, for example:
unlocking and/or locking and/or opening and/or closing of a closure means (e.g. a door and/or shutter) of the shipment storage apparatus,
a presence of one or more persons (e.g. the user) in the storage space and/or a part of the storage space,
an image (e.g. a still image) and/or multiple images (e.g. an image sequence and/or moving images in the form of a video) of the storage space and/or a part of the storage space,
a sound capturable in the storage space and/or a part of the storage space (e.g. an acoustic event in the form of speech, music and/or other sounds).

Examples of sensors for capturing these storage space parameters are an opening sensor for detecting the opening and/or closing of a closure means (e.g. a door opening sensor), a motion sensor for detecting a presence of one or more persons (e.g. a motion detector), a light sensor (e.g. a brightness sensor, a photodiode and/or a photoresistor, e.g. for a light barrier for detecting when one or more persons enter and/or leave the storage space and therefore for detecting a presence of one or more persons), a radio sensor for detecting a presence of one or more user apparatuses of one or more persons and therefore for detecting a presence of one or more persons (e.g. a wireless communication interface such as a WLAN, RFID, NFC and/or Bluetooth sensor), an acoustic sensor for capturing a sound (e.g. a microphone and/or a sound sensor), an image sensor for capturing one or more images (e.g. a still-image and/or video camera, a CMOS sensor and/or a CCD sensor). It goes without saying that this list is only exemplary and not conclusive.

These storage space parameters permit monitoring and/or logging of the actions of a user while the user is in the storage space. This is advantageous, by way of example, in order to be able to reconstruct the actions of the user if it is determined that the user is unauthorisedly accessing one of the shipment retainers.

It goes without saying that the capture of one or more parameters (e.g. of one or more storage space parameters and/or of one or more shipment retainer parameters) and/or the causing of the capture of one or more parameters (e.g. by one or more sensors, e.g. by one or more sensors of the shipment retainers and/or sensors arranged in the storage space) may also be part of the method (i.e. comprised by the method). The causing of the capture of one or more parameters can be effected by virtue of one or more sensors being actuated, for example. Actuating a respective sensor is intended to be understood to mean, by way of example, that control information is sent (e.g. by a communication interface of the control apparatus) to the respective sensors (e.g. to a communication interface of the respective sensor) that are configured to cause the respective sensor to capture one or more of the parameters.

In an exemplary embodiment of the invention, the determining of whether the user accesses only the one or more of the shipment retainers that the access authorization information authorises the user to access is effected according to one or more predetermined rules and/or according to a pattern recognition algorithm and/or according to a machine learning algorithm.

As disclosed above, in the event of particular sensor information that contains and/or represents a shipment parameter suggesting access to a respective shipment retainer being obtained, for example, the predetermined rules can stipulate that if the access authorization information does not authorise the user to access this respective shipment retainer then it is determined that the user is unauthorisedly accessing this respective shipment retainer. A pattern recognition algorithm can take a pattern represented by and/or contained in the sensor information, for example, as a basis for detecting access (e.g. possible access) to a respective shipment retainer and can therefore help to determine whether the user accesses only the one or more of the shipment retainers that the access authorization information authorises the user to access. This also applies accordingly to a machine learning algorithm that is trained with sensor information obtained during one or more instances of access to shipment retainers, for example, so as to be able to thus detect access (e.g. possible access) to a respective shipment retainer.

In an exemplary embodiment of the invention, the method further comprises:
if it is determined that the user unauthorisedly accesses at least one shipment retainer of the shipment retainers that the access authorization information does not authorize the user to access, triggering and/or causing the triggering of a first alarm action.

By way of example, the first alarm action is a local alarm action perceptible (e.g. audibly and/or visually perceptible) by a user in the storage space and/or in an area surrounding the shipment storage apparatus. Accordingly, the triggering of the first alarm action is intended to be understood to mean the output of a signal (e.g. an audible and/or visual signal) perceptible by a user in the storage space and/or in an area surrounding the shipment storage apparatus. This is advantageous, by way of example, in order to make the user aware that it has been determined that the user is unauthorisedly accessing at least one shipment retainer of the shipment retainers. The user is thus provided with the opportunity to reverse and/or end the unauthorised access, for example.

For example, the first alarm action is performed by a signal transmitter of the shipment storage apparatus, in particular an audible and/or visual signal transmitter for outputting an audible and/or visual signal. The signal transmitter may be arranged in the storage space.

The causing of the triggering of the first alarm action can be effected by virtue of such a signal transmitter of the shipment storage apparatus being actuated, for example, in order to cause the signal transmitter to output an applicable signal. For example, applicable control information configured to cause the signal transmitter to output such a signal is sent (e.g. by a communication interface of the control apparatus) to the signal transmitter (e.g. to a communication interface of the signal transmitter).

Further, the method can, by way of example, comprise:
if it is determined that the user continues to unauthorisedly access the at least one shipment retainer of the shipment retainers after a predetermined period has elapsed after the triggering and/or causing of the triggering of the first alarm action, triggering and/or causing of the triggering of a second alarm action.

For example, the second alarm action comprises notifying and/or causing the notification of one or more further users and/or logging and/or causing the logging of the unauthorized access.

The notifying of one or more further users (e.g. of one or more further users of the shipment storage apparatus) is effected, by way of example, by virtue of a message (e.g. a voice message, a text message and/or an email message) being sent to the further users and/or to respective user apparatuses (e.g. portable user apparatuses) of the further users. In this case, a message is intended to be understood as sent to a user and/or to a user apparatus of the user if the message is sent to a message address associated with the user (e.g. an email address and/or a phone number) and/or to a user apparatus associated with the user (e.g. to a network address such as an IP (Internet Protocol) address of the user apparatus associated with the user). Applicable information (e.g. information representing a message address of the further users) may be stored in a user database, for example. This is advantageous, by way of example, in order to make the further users aware of possible unauthorised access.

The logging of the access can be effected by storing log information representing and/or containing the access authorization information, for example. Further, the log information can contain and/or represent a time stamp (e.g. a statement indicating the time of the unauthorized access) and/or sensor information (e.g. sensor information containing and/or representing one or more shipment retainment parameters and/or one or more storage space parameters), for example. The log information may be stored in a log database (e.g. in a memory of the control apparatus), for example. This is advantageous, by way of example, in order to be able to retrospectively resolve whether unauthorised access has actually taken place.

The causing of the notification and/or the causing of the logging is intended to be understood to mean that another (one or more other) apparatus(es), as an apparatus performing the method (e.g. the control apparatus), are caused to perform the notification and/or logging. For example, the one (or more) other apparatus(es) can be actuated as appropriate (e.g. by virtue of applicable control information being sent to the one (or more) other apparatus(es), prompting the one (or more) other apparatus(es) to notify one or more further users and/or to log the unauthorised access).

Further advantageous exemplary configurations of the invention can be found in the detailed description of a few exemplary embodiments of the present invention that follows, in particular in conjunction with the figures. The figures accompanying the application are intended to be used only for the purpose of clarification, however, rather than for determining the scope of protection of the invention. The accompanying drawings are not necessarily to scale and are merely intended to reflect the general concept of the present invention by way of example. In particular, features included in the figures are by no means intended to be considered to be a necessary part of the present invention.

### BRIEF DESCRIPTION OF THE DRAWINGS

In the drawings:

FIG. 1 shows a schematic depiction of an exemplary embodiment of a control apparatus disclosed according to the invention;

FIG. 2 shows a schematic depiction of an exemplary embodiment of a system disclosed according to the invention;

FIG. 3 shows a flowchart for an exemplary embodiment of a method disclosed according to the invention; and

FIG. 4 shows exemplary embodiments of storage media.

### DETAILED DESCRIPTION

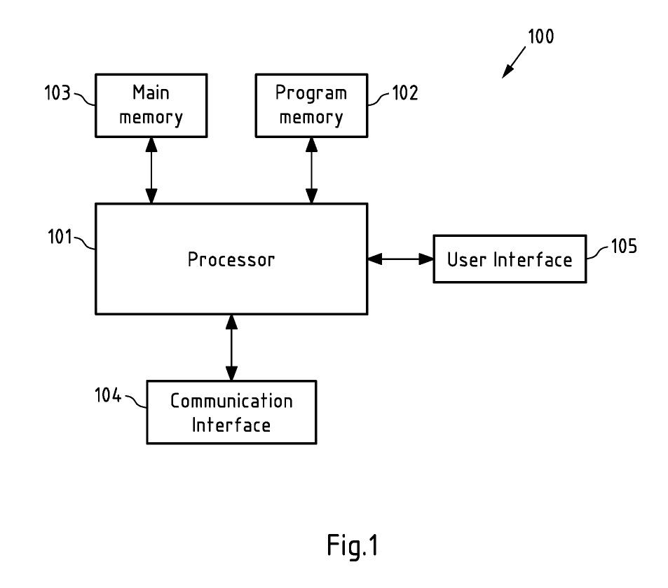

FIG. 1 is a schematic depiction of an exemplary embodiment of a control apparatus 100 disclosed according to the invention.

The control apparatus 100 comprises, by way of example, a processor 101 and, connected to the processor 101, a first memory as a program and data memory 102, a second memory as a main memory 103, a communication interface 104 and a user interface 105.

A processor is intended to be understood to mean, by way of example, a microprocessor, a microcontrol unit, a microcontroller, a digital signal processor (DSP), an application-specific integrated circuit (ASIC) or a field programmable gate array (FPGA). It goes without saying that the apparatus 100 can also comprise multiple processors 101.

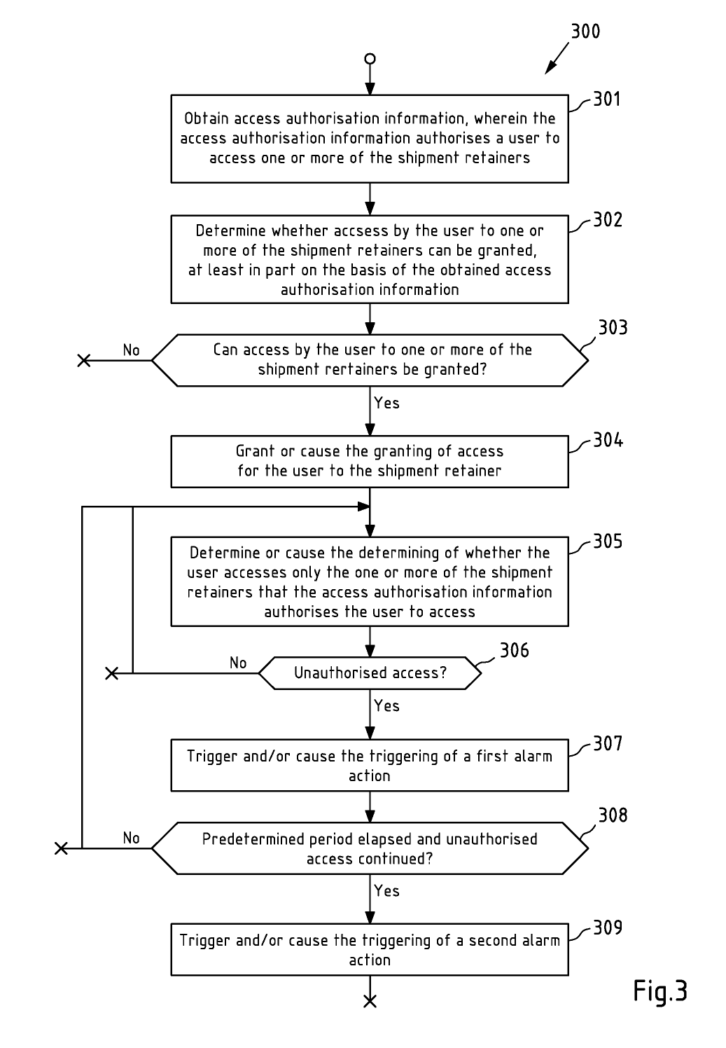

Processor 101 executes programming instructions stored in program memory 102 and stores, by way of example, intermediate results or the like in main memory 103. The program memory 102 contains, by way of example, program instructions of a computer program (e.g. a computer program disclosed according to the invention) that cause the processor 101 to perform and/or control a method disclosed according to the invention (e.g. the method according to the flowchart 300 depicted in FIG. 3) when the processor 101 executes these program instructions stored in program memory 102. Moreover, program memory 102 may store, by way of example, one or more databases (e.g. a user database and a shipment storage database) or representations or one or more databases.

Program memory 102 further contains, by way of example, the operating system of the control apparatus 100, which is loaded at least in part into main memory 103 when the control apparatus 100 is started, and is executed by the processor 101. In particular, when the control apparatus 100 is started, at least a part of the core of the operating system is loaded into the main memory 103 and executed by processor 101.

An example of an operating system is a Windows, UNIX, Linux, Android, Apple iOS and/or MAC OS operating system. The operating system in particular allows the use of the control apparatus for information and/or data processing. By way of example, it manages resources such as a main memory and a program memory, uses programming interfaces, inter alia, to provide other computer programs with fundamental functions and controls the execution of computer programs.

A program memory is, by way of example, a non-volatile memory such as a Flash memory, a magnetic memory, an EEPROM (Electrically Erasable Programmable Read Only Memory) and/or an optical memory. A main memory is, for example, a volatile or non-volatile memory, in particular a random access memory (RAM) such as a static RAM (SRAM), a dynamic RAM (DRAM), a ferroelectric RAM (FeRAM) and/or a magnetic RAM (MRAM).

Main memory 103 and program memory 102 may also be designed as one memory.

Alternatively, main memory 103 and/or program memory 102 may each be formed by multiple memories. Further, main memory 103 and/or program memory 102 may also be part of the processor 101.

Processor 101 controls the communication interface 104, which is designed as a wireless and/or wired communication interface, for example. A wireless and/or wired communication interface can, by way of example, receive information (via a wireless and/or wired communication path) and forward it to the processor 101 and/or can receive information from the processor 101 and send it (via a wireless and/or wired communication path).

An example of a wireless communication interface is a wireless network adapter. For example, a wireless communication interface comprises, besides an antenna, at least one transmitter circuit and one receiver circuit or a transceiver circuit. Examples of a wireless communication interface are a GSM, UMTS and/or LTE interface and/or a WLAN and/or Bluetooth interface. As disclosed above, the GSM, UMTS and LTE specifications are maintained and developed by the 3rd Generation Partnership Project (3GPP) and are currently available on the Internet at www[dot]3gpp[dot]com. WLAN is specified in the standards of the IEEE-802.11 family, for example. The Bluetooth specifications are currently available on the Internet at www[dot]Bluetooth[dot]org.

An example of a wired communication interface is a wired network adapter. For example, a wired communication interface comprises at least one transmitter circuit and one receiver circuit or a transceiver circuit. An example of a wired communication interface is an Ethernet interface. Ethernet is specified in the standards of the IEEE-802.3 family, inter alia.

The communication interface 104 is configured for receiving information (e.g. access authorization information and/or sensor information) and/or for sending information (e.g. control information), for example.

Further, processor 101 controls the user interface 105, which is configured for capturing information (e.g. access authorization information) in the form of a user input (e.g. as a keyboard or mouse input and/or as a voice input and/or as a gesture) and/or for outputting information in the form of a, by way of example, audible and/or visual user output (e.g. as a voice output and/or as a text output). A user interface is a keyboard, a mouse, a camera, a screen, a touch-sensitive screen, a loudspeaker and/or a microphone, for example.

The components 101 to 105 of the control apparatus 100 are communicatively and/or operatively connected to one another via one or more bus systems (e.g. one or more serial and/or parallel bus connections), for example.

It goes without saying that the control apparatus 100 can comprise further components besides the components 101 to 105.

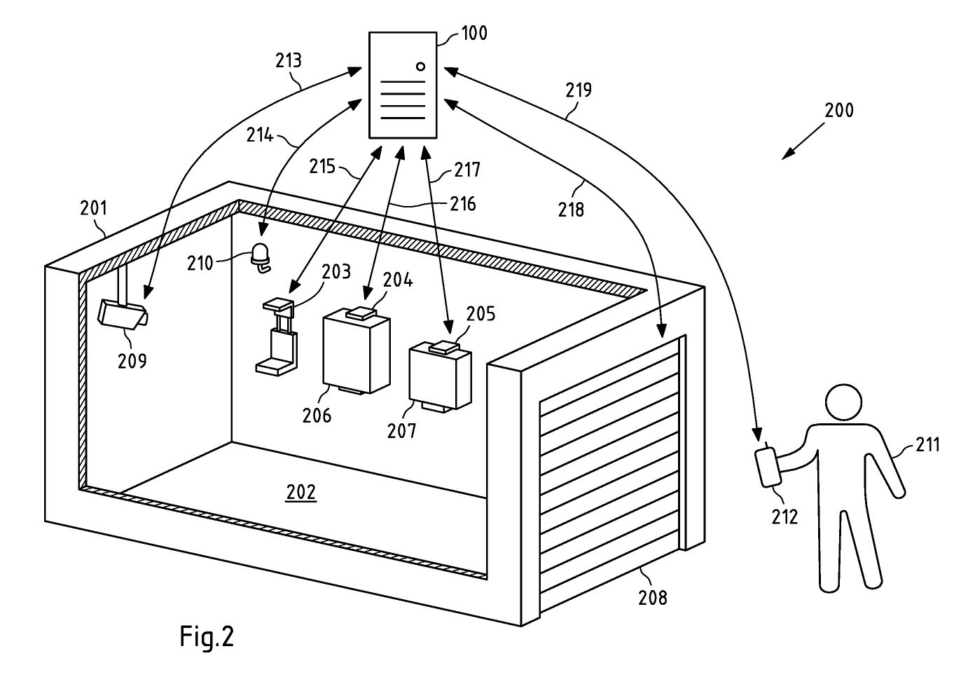

FIG. 2 shows a schematic depiction of an exemplary embodiment of a system 200 disclosed according to the invention.

System 200 comprises, inter alia, a shipment storage apparatus 201, depicted as a garage, having a storage space 202 in which multiple shipment retainers 203, 204 and 205 are arranged. For example, the shipment retainers 203, 204 and 205 are mounted (e.g. by means of a threaded insert joint and/or an adhesive bond) on a wall of the garage 201 that encloses the storage space 202.

As disclosed above, a shipment retainer is an apparatus for retaining a shipment, for example.

The shipment retainers 203, 204 and 205 are, by way of example, configured to retain a respective shipment by means of a force-fit clamp connection. For example, the shipment retainers 204 and 205 retain a respective one of the shipments 206 and 207. Each of the shipment retainers can comprise one or more optional sensors (not depicted) for capturing one or more shipment retainer parameters. As disclosed above, a shipment retainer parameter of one of the shipment retainers 203, 204 and 205 may be one of the following shipment retainer parameters:
a weight of a shipment retained by the respective shipment retainer,
a vibration in the respective shipment retainer,
opening and/or closing of a closure means of the respective shipment retainer,
damage to the respective shipment retainer and/or to a part of the respective shipment retainer,
a tag on a shipment retained by the respective shipment retainer.

It is subsequently assumed by way of example that each of the shipment retainers 203, 204 and 205 comprises at least one respective pressure sensor for detecting a weight of a shipment retained by the respective shipment retainer.

As depicted in FIG. 2, the garage 201 has a door 208 by means of which the storage space 202 is accessible. It is subsequently assumed by way of example that the door 208 is a garage door having an electrically actuatable garage door drive for opening and closing the garage door.

Further, storage space 202 has an optional sensor in the form of a monitoring camera 209 for capturing one or more images of a part of the storage space and an optional signal transmitter in the form of a signal light 210 arranged in it.

Furthermore, FIG. 2 depicts a user 211 having a portable user apparatus 212. The portable user apparatus 212 is a smartpone of the user 211, for example.

FIG. 2 depicts the control apparatus 100 disclosed in connection with FIG. 1 as a server, remote from the garage 201 (i.e. the shipment storage apparatus), of a delivery service (e.g. a backend server of the delivery service), by way of example. In such an embodiment, the control apparatus 100 is a control apparatus for multiple shipment storage apparatuses (that is to say not only garage 201 but also one or more further shipment storage apparatuses), for example. Alternatively, the control apparatus 100 could also be a control apparatus just for the garage 201, however, and be arranged in the storage space 202, for example. However, it is subsequently assumed by way of example that the control apparatus 100 is a control apparatus for multiple shipment storage apparatuses in the form of a server of the delivery service that is remote from the garage 201 (i.e. the shipment storage apparatus).

For example, the owner has made the garage 201 available to the delivery service for the storage of shipments in the course of the transport and deliveries of shipments by the delivery service.

For example, users (e.g. senders and recipients of shipments) can register with the delivery service to collect and deposit shipments in the garage 201. For example, there may be provision for each of the registered users to be permitted to use one or more shipment storage apparatuses such as the garage 201 for the collection and/or depositing of shipments. In this regard, a user database may be provided that contains and/or represents user information for the users registered with the delivery service. For example, the user database contains, for each of the registered users, a user database entry that contains and/or represents the explicit identifier of the respective user and the explicit identifier(s) of the shipment storage apparatus(es) that the respective user can use for collecting and/or depositing shipments.

Further, a shipment storage database may be provided that contains and/or represents shipment storage information. In this case, shipment storage information is intended to be understood to mean, by way of example, a statement indicating whether a shipment retainer is free or occupied, for example in the form of a shipment storage database entry that, when the shipment retainer is occupied, represents and/or contains the identifier of the shipment retainer and the identifier of the shipment retained by the shipment retainer and, when the shipment retainer is free, contains and/or represents the identifier of the shipment retainer and information indicating that the shipment retainer is free. Shipment storage information may moreover be a statement indicating which shipment retainer retains a shipment, for example in the form of a shipment storage database entry that contains and/or represents the identifier of the shipment and the identifier of the shipment retainer that retains the shipment.

The user database and/or the shipment storage database may be stored in program memory 102 of the control apparatus 100 or separately from the control apparatus 100, for example in a memory of a database apparatus. If the user database and/or the shipment storage database are stored separately from the control apparatus 100, there is provision, by way of example, for the control apparatus 100 to be able to access the user database and/or the shipment storage database (e.g. via the communication interface 104) and/or request user information from the user database and/or shipment storage information from the shipment storage database. It is subsequently assumed that the user database and the shipment storage information are stored in program memory 102 of the control apparatus 100 and maintained by the control apparatus 100.

The control apparatus 100 can use the communication paths 213 to 219 (e.g. by means of communication interface 104) to communicate with the components 203, 204, 205, 208, 209, 210 and 212 of the system 200 (i.e. to send and receive information). Each of the components 203, 204, 205, 208, 209, 210 and 212 of the system 200 has an applicable communication interface, for example. It goes without saying that the communication along the communication paths 213 to 219 can be effected directly between the respective component and the control apparatus 100 or that the communication along the communication paths 213 to 219 includes one or more further components, for example the storage space 202 could have, as one such further component, a hub arranged in it that receives information (e.g. access authorization information and/or sensor information) from the components 203, 204, 205, 208, 209, 210 and 212 and forwards it to the control apparatus and receives information (e.g. control information) from the control apparatus 100 and forwards it to one or more of the components 203, 204, 205, 208, 209, 210 and 212. The communication paths 213 to 219 can run via one or more networks (e.g. a wireless communication network such as a WLAN network and/or a mobile radio network and/or the Internet).

For example, there may be provision that, when a sender of a shipment or a delivery agent deposits a shipment in one of the shipment retainers 203, 204 and 205, a user apparatus of the sender or delivery agent sends applicable deposit information containing and/or representing the identifier of the shipment and the identifier of the shipment retainer in which the shipment has been deposited, for example, to the control apparatus 100. To this end, the sender or delivery agent can scan in the identifier of the shipment (e.g. a barcode printed on the shipment) and the identifier of the shipment retainer (e.g. a barcode printed on the shipment retainer), for example, using his user apparatus and subsequently cause the deposit information to be sent. When the control apparatus 100 receives the deposit information, it maintains the shipment storage database accordingly, for example by producing and/or updating a shipment storage database entry such that it represents and/or contains the identifier of the shipment retainer and the identifier of the shipment deposited in the shipment retainer. Further, there may be provision, for example, that when the shipment has been deposited by a delivery agent the recipient of the deposited shipment is sent a notification (e.g. by the control apparatus 100) indicating that the shipment has been deposited in the garage 201.

Further, there may be provision that, when a recipient of a shipment or a delivery agent collects one of the shipments (e.g. shipment 206 or 207) retained by the shipment retainers 203, 204 and 205, the user apparatus of the recipient or delivery agent sends applicable collection information containing and/or representing the identifier of the shipment and the identifier of the shipment retainer that has retained the shipment, for example, to the control apparatus 100. To this end, the recipient or delivery agent can scan in the identifier of the shipment (e.g. a barcode printed on the shipment) and the identifier of the shipment retainer (e.g. a barcode printed on the shipment retainer), for example, using his user apparatus and can subsequently cause the deposit information to be sent. Alternatively or additionally, there may be provision for the shipment retainer that has retained the shipment to send applicable collection information with the identifier of the shipment retainer and information indicating that the shipment retainer is free to the control apparatus 100 if the pressure sensor of the shipment retainer detects a change in the weight of the shipment retained by the shipment retainer (e.g. if the detected weight is below a predetermined weight threshold value). When the control apparatus 100 receives the collection information, it maintains the shipment storage database accordingly, for example by producing and/or updating a shipment storage database entry such that it represents and/or contains the identifier of the shipment retainer and information indicating that the shipment retainer is free.

FIG. 3 shows a flowchart 300 having steps of an exemplary embodiment of a method disclosed according to the invention. Steps 301 to 309 of the flowchart 300 can be performed by a control apparatus such as the control apparatus 100 disclosed above in connection with FIG. 1 and FIG. 2, for example. It is subsequently assumed by way of example that steps 301 to 309 of the flowchart 300 are performed by the control apparatus 100 in the system 200 depicted in FIG. 2.

In a step 301, access authorization information is obtained. For example, the access authorization information is received from the portable user apparatus 212 (e.g. received by the communication interface 104 of the control apparatus 100 via communication path 219) in step 302. The access authorization information authorises the user 211 to access one or more of the shipment retainers 203, 204 and 205, for example.

As disclosed in detail above, the access authorization information can contain and/or represent one or more access authorization parameters. The access authorization parameters are used for verifying and/or defining the authorization of the user 211 to access one or more of the shipment retainers 203, 204 and 205, for example.

The access authorization information may be access authorization information for collecting of at least one shipment, for example. If the user 211 is a recipient of the shipments 206, he has received, for example via his user apparatus 212, a notification from the control apparatus 100 indicating that the shipment 206 has been deposited in the garage 201. Further, the notification contains, by way of example, access authorization information authorising the user 211 to access the shipment retainer 204 that retains the shipment 206. In this regard, this access authorization information for collecting of the shipment 206 contains and/or represents at least one explicit identifier for the shipment 206 or for the shipment retainer 204 that retains the shipment 206.

Alternatively or additionally, the access authorization information may be access authorization information for depositing of at least one shipment, for example. If the user 211 intends to send a shipment (i.e. he is a sender of this shipment), for example, he can use his user apparatus 212, for example, to request a notification with access authorization information for depositing of at least one shipment in the garage 201 (e.g. by sending an applicable request to the control apparatus 100) and can obtain said notification (e.g. receive it from the control apparatus 101) by means of his user apparatus 212. Such access authorization information authorises the user 211 to access a free shipment retainer of the shipment retainers 203, 204 and 205, for example. In this regard, the access authorization information for depositing of a shipment contains and/or represents at least one explicit identifier for a free shipment retainer (e.g. the shipment retainer 203) or information indicating that the user 211 is authorised to access at least one free shipment retainer of the shipment retainers 203, 204 and 205 in the garage 201. Further, the access authorization information can contain and/or represent an explicit identifier for the user 211.

If, by contrast, the user 211 is a delivery agent intended to deposit a shipment in the garage 201 and collect the shipment 207, for example, the access authorization information can authorise the user 211 to access all shipment retainers 203, 204 and 205. In this regard, the access authorization information contains and/or represents information indicating that the user 211 is authorised to access all shipment retainers 203, 204 and 205 in the garage 201.

Further, the access authorization information in each of the examples cited above can contain and/or represent an explicit identifier for the user 211.

In a step 302, it is determined, at least in part on the basis of the access authorization information obtained in step 301, whether access by the user 211 to one or more of the shipment retainers 203, 204 and 205 can be granted.

Determining whether access by the user to one or more of the shipment retainers can be granted, at least in part on the basis of the obtained access authorization information, is intended to be understood to mean, by way of example, that a check is performed to determine whether the access authorization information obtained in step 301 authorises the user 211 to access one or more of the shipment retainers. The check can be performed at least in part on the basis of the user database disclosed above, for example. For example, in step 302, an identifier for the user 211 that is represented by and/or contained in the access authorization information obtained in step 301, for example, can first of all be used to check whether the user 211 is registered with the delivery service and is permitted to use the garage 201 for collecting and/or depositing shipments.

If the user 211 is not permitted to use the garage 201 for collecting and/or depositing shipments, it is determined in step 302 that access by the user 211 to one or more of the shipment retainers 203, 204 and 205 cannot be granted, for example. Otherwise, in step 302, a check is additionally performed, by way of example, to determine whether the access authorization information obtained in step 301 authorises the user to access one of the shipment retainers 203, 204 and 205, for example authorises him to collect at least one shipment retained in one of the shipment retainers 203, 204 and 205 and/or to deposit at least one shipment in one of the shipment retainers 203, 204 and 205. This additional check can be performed at least in part on the basis of the shipment storage database disclosed above. In respect of this additional check, the following cases are conceivable, inter alia:
(i) If the access authorization information contains and/or represents an explicit identifier for the shipment retainers 203 (e.g. for depositing a shipment) or 204 (e.g. for collecting the shipment 206), it is determined in step 301, by way of example, that access by the user 211 only to the shipment retainer 203 or 204 can be granted.
(ii) If the access authorization information contains and/or represents an explicit identifier for the shipment 206 (e.g. for collecting the shipment 206), a check is performed in step 301, by way of example, at least in part on the basis of the shipment storage database, to determine whether the shipment 206 is retained by one of the shipment retainers 203, 204 and 205 (e.g. whether a shipment storage database entry representing and/or containing the identifier of the shipment 206 and the identifier of one of the shipment retainers 203, 204 and 205 exists). Only if the shipment 206 is retained by one of the shipment retainers 203, 204 and 205 (e.g. if such a shipment storage database entry exists) is it determined in step 301, by way of example, that access by the user 211 only to this shipment retainer (i.e. shipment retainer 204) can be granted.
(iii) If the access authorization information contains and/or represents information indicating that the user 211 is authorised to access at least one free shipment retainer of the shipment retainers 203, 204 and 205 in the garage 201, a check is performed in step 301, by way of example, at least in part on the basis of the shipment storage database, to determine whether one of the shipment retainers 203, 204 and 205 is free (e.g. whether a shipment storage database entry representing and/or containing the identifier of one of the shipment retainers 203, 204 and 205 and information indicating that one of the shipment retainers 203, 204 and 205 is free exists). Only if one of the shipment retainers 203, 204 and 205 is free (e.g. if such a shipment storage database entry exists) is it determined in step 301, by way of example, that access by the user 211 only to the free shipment retainer (i.e. shipment retainer 203) can be granted.
(iv) If the access authorization information contains and/or represents information indicating that the user 211 is authorised to access all shipment retainers 203, 204 and 205 in the garage 201, it is determined in step 301, by way of example, that access by the user 211 to all shipment retainers 203, 204 and 205 can be granted.

If the result of the determining in step 302 is that access by the user 211 to one or more of the shipment retainers 203, 204 and 205 cannot be granted, the flowchart 300 is terminated in a step 303. Otherwise, the flowchart is continued with a step 304.

In a step 304, access is granted for the user 211 to the storage space 202 and/or granting of the access is caused.

Access can be granted for the user 211 to the storage space 202 by unlocking and/or opening the door 208, for example. Causing the granting of the access for the user 211 to the storage space 202 is intended to be understood to mean, by way of example, that the granting of access is controlled, for example by virtue of the door 208 being actuated such that it unlocks and/or opens. As disclosed above, the door 208 is a garage door having an electrically actuatable garage door drive for opening and closing the garage door. Accordingly, the control apparatus can send control information to the door 208 (e.g. by means of communicating interface 104 of the control apparatus 100 via communication path 218), for example, in step 302 that is configured to cause the garage door drive to open the garage door.

In a step 305, it is determined whether the user 211 accesses only one or more of the shipment retainers 203, 204 and 205 that the access authorization information authorises the user 211 to access.

The determining, in step 305, of whether the user 211 accesses only the one or more of the shipment retainers that the access authorization information authorises the user 211 to access comprises, by way of example, the monitoring, by the control apparatus 100, of whether the user accesses one or more of the shipment retainers that the access authorization information does not authorise the user to access. This can be effected at least in part on the basis of sensor information, for example, as disclosed in detail below.

For example, the determining in step 305 is based at least in part on sensor information. Sensor information represents a parameter captured by a sensor at the position of the sensor (e.g. a measured value for a physical or chemical variable capturable at the position of the sensor), for example. The sensor information represents parameters captured by one or more different sensors (e.g. by at least two different sensors), for example.

For example, the sensor information can be obtained at least in part by virtue of one or more parameters being captured by one or more sensors (e.g. if the sensors are, at least in part, part of the control apparatus 100). Alternatively or additionally, the sensor information can also be obtained at least in part by virtue of the sensor information being received (e.g. by the communication interface 104 of the control apparatus 100) (e.g. if the sensors are, at least in part, external to the control apparatus 100, like the video camera 209 and/or the pressure sensors of the shipment retainers 203, 204 and 205).

For example the sensor information represents one or more parameters, wherein the parameters are captured by one or more sensors arranged in the storage space and/or by one or more sensors of the shipment retainers.

As disclosed above, each of the shipment retainers 203, 204 and 205 comprises at least one respective pressure sensor for detecting a weight of a shipment retained by the respective shipment retainer.

If the weight of a shipment retained by the respective shipment retainer changes, then this infers that the shipment retained by the respective shipment retainer has changed, e.g. because a shipment has been deposited in the respective shipment retainer or a shipment or part of a shipment has been taken from the respective shipment retainer. A change in this shipment retainer parameter (i.e. in a weight of a shipment retained by the respective shipment retainer) thus suggests possible access to the respective shipment retainer. The capture of these shipment retainer parameters is therefore advantageous in order to be able to determine whether possible access to one or more of the shipment retainers takes place.

For example, it may be stipulated that, if a change in a weight of a retained shipment is detected by a sensor of a respective shipment retainer, it is determined in step 305 that access to this respective shipment retainer is taking place. If the access authorization information obtained in step 301 does not authorise the user to access this respective shipment retainer, it is further determined in step 305, by way of example, that the user 211 is unauthorisedly accessing this respective shipment retainer. It goes without saying that if the sensor information suggests possible access and this is subsequently determined accordingly in step 305 based on the sensor information, access does not necessarily also actually need to be taking place (e.g. because a sensor is faulty or another event has led to the sensor information).

Alternatively, the determining in step 305 by the control apparatus 100 can also just be caused. In this case, causing the determining in step 305 is intended to be understood to mean, by way of example, that the control apparatus 100 causes the shipment retainers 203, 204 and 205 to monitor whether the user 211 accesses one or more of the shipment retainers 203, 204 and 205 that the access authorization information does not authorise the user 211 to access.

For example, in step 305, the control apparatus sends each of the shipment retainers 203, 204 and 205 that the access authorization information does not authorise the user to access control information (e.g. via one or more of the communication paths 215, 216 and 217 through the communication interface 104 of the control apparatus 100) configured to cause the respective shipment retainer to monitor whether the user 211 (unauthorisedly) accesses it. Alternatively, there may also be provision for each of the shipment retainers 203, 204 and 205 to continuously monitor whether a user (unauthorisedly) accesses it. In this case, in step 305, each of the shipment retainers 203, 204 and 205 that the access authorization information authorises the user 211 to access, for example, can be sent control information (e.g. via one or more of the communication paths 215, 216 and 217 through the communication interface 104 of the control apparatus 100) configured to cause the respective shipment retainer to interrupt the monitoring (e.g. until the user has deposited or taken a shipment in or from the respective shipment retainer). The respective shipment retainers of the shipment retainers 203, 204 and 205 can than accordingly determine, at least in part on the basis of sensor information, as disclosed in detail above for the control apparatus 100, whether the user 211 accesses them and, by way of example, if it is determined that (e.g. unauthorised, access is taking place, can send access information to the control apparatus 100 (e.g. via one of the communication paths 215, 216 and 217) containing and/or representing information indicating that (e.g. unauthorised) access to the respective shipment retainer is taking place.

While it is not determined in step 305 that unauthorised access by the user 211 is taking place (i.e. the user 211 accesses only the one more of the shipment retainers that the access authorization information authorises the user 211 to access) and a presence of the user 211 in the storage space 202 is detectable, for example, the monitoring in step 305 is continued. If a presence of the user 211 in the storage space 202 is not detectable (e.g. because the user 211 has left the storage space 202 after having deposited or collected a shipment) without it being determined in step 305 that unauthorised access by the user 211 is taking place, the flowchart 300 is terminated, for example, in an optional step 306 and the door 208 is closed. Whether a presence of the user 211 in the storage space 202 is detectable can be determined, by way of example, at least in part on the basis of sensor information received at the control apparatus from the video camera 209 (e.g. via the communication path 213 through the communication interface 104 of the control apparatus 100) representing and/or containing one or more images of the storage space 202 or of a part of the storage space that are captured by the video camera 209.

If, however, it is determined in step 305 that unauthorised access by the user 211 is taking place (i.e. the user 211 accesses one or more of the shipment retainers that the access authorization information does not authorise the user 211 to access), the flowchart is continued with an optional step 307.

In an optional step 307, a first alarm action is triggered and/or the triggering of the first alarm action is caused.

By way of example, the first alarm action is a local alarm action perceptible (e.g. audibly and/or visually perceptible) by the user 211 in the storage space 202 and/or in an area surrounding the garage 201. Accordingly, the triggering of the first alarm action is intended to be understood to mean the output of a signal perceptible by a user 211 in the storage space 202 and/or in an area surrounding the garage 201. For example, a visual signal can be output by the visual signal transmitter 210 arranged in the storage space 202 in step 307.

The causing of the triggering of the first alarm action can be effected by actuating the visual signal transmitter 210, for example, in order to cause the visual signal transmitter 210 to output a visual signal. For example, in step 307, applicable control information configured to cause the visual signal transmitter 210 to output a visual signal is sent to the visual signal transmitter 210 (e.g. via the communication path 214 through the communication interface 104 of the control apparatus 100).

In an optional step 308, after a predetermined period has elapsed after the triggering and/or causing of the triggering of the first alarm action, it is determined whether the user 211 continues to unauthorisedly access the at least one shipment retainer of the shipment retainers. In this case, the determining of whether the user 211 continues to unauthorisedly access the at least one shipment retainer of the shipment retainers 203, 204 and 205 can proceed in accordance with the determining disclosed in connection with step 305, for example.

If the user 211 ends and/or reverses the unauthorised access and a presence of the user 211 in the storage space 202 is detectable, for example, the flowchart is continued with step 305. If the user 211 ends and/or reverses the unauthorised access and a presence of the user 211 in the storage space 202 is not detectable (e.g. because the user 211 has left the storage space 202), the flowchart 300 is terminated in step 308, for example, and the door 208 is closed. As disclosed above, it can be determined whether a presence of the user 211 in the storage space 202 is detectable at least in part on the basis of sensor information received at the control apparatus from the video camera 209 (e.g. via the communication path 213 through the communication interface 104 of the control apparatus 100), for example.

If it is determined in step 308 that the user 211 continues to unauthorisedly access the at least one shipment retainer of the shipment retainers after the predetermined period has elapsed after the triggering and/or causing of the triggering of the first alarm action, a second alarm action is triggered and/or the triggering of the second alarm action is caused in an optional step 309.

For example, the second alarm action comprises notifying and/or causing the notification of one or more further users and/or logging and/or causing the logging of the unauthorized access.

The notifying of one or more further users (e.g. one or more further users of the shipment storage apparatus) is effected by sending a message (e.g. a voice message, a text message and/or an email message) to the further users and/or to respective user apparatuses (e.g. portable user apparatuses) of the further users, for example. In this case, a message is intended to be understood as sent to a user and/or to a user apparatus of the user if the message is sent (e.g. by the communication interface 104 of the control apparatus 100) to a message address associated with the user (e.g. an email address and/or a phone number) and/or to a user apparatus associated with the user (e.g. to a network address such as an IP (Internet Protocol) address of the user apparatus associated with the user). For example, the further users are likewise registered with the delivery service for the collection and depositing of shipments in the garage 201. Applicable information (e.g. information representing a message address of the further registered users) may be stored in the user database, for example.

The logging of the access can be effected by storing log information representing and/or containing the access authorization information obtained in step 301, for example. Further, the logging information can contain and/or represent a time stamp (e.g. a statement indicating the time of the unauthorised access) and/or sensor information such as sensor information (e.g. sensor information containing and/or representing one or more shipment retainer parameters and/or one or more storage space parameters), for example. The logging information can be stored in a log database in program memory 102 of the control apparatus 100, for example.

The causing of the notification and/or the causing of the logging is intended to be understood such that a (or multiple) apparatus(es) separate from the control apparatus are caused to perform the notification and/or logging (e.g. by virtue of the control apparatus sending appropriately configured control information to the separate apparatuses).

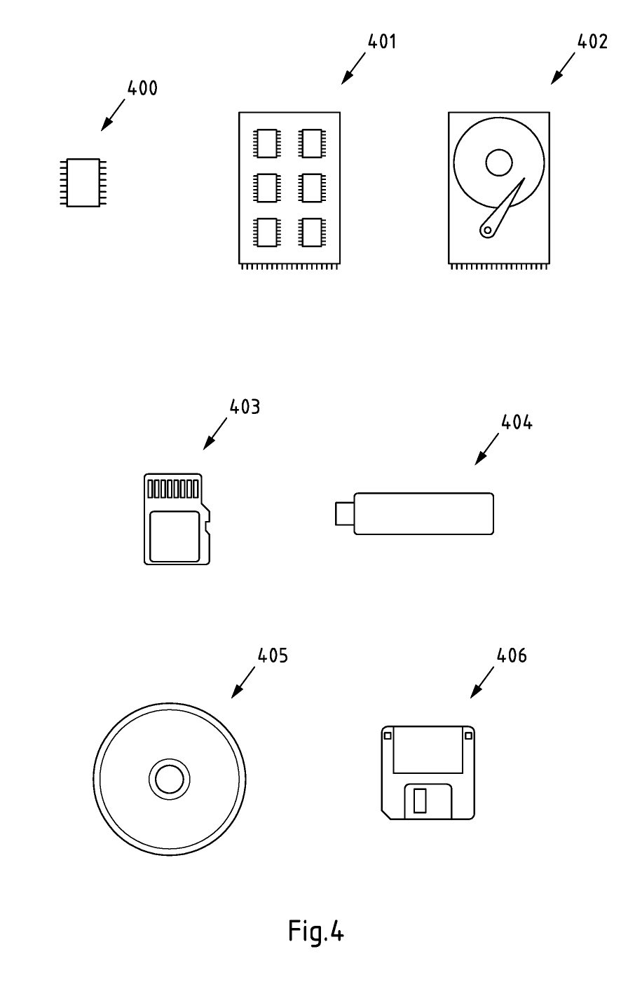

Finally, FIG. 4 shows exemplary embodiments of storage media on which an exemplary embodiment of a disclosed computer program may be stored. The storage medium may, by way of example, be a magnetic, electrical, optical and/or other kind of storage medium. The storage medium may, by way of example, be part of a processor (e.g. the processor 101 of the control apparatus 100 from FIG. 1), for example a (non-volatile or volatile) program memory of the processor or a part thereof (e.g. program memory 102). Exemplary embodiments of a storage medium are a flash memory 400, an SSD hard disc 401, a magnetic hard disc 402, a memory card 403, a memory stick 404 (e.g. a USB stick), a CD-ROM or DVD 405 of a floppy disc 406.

The exemplary embodiments of the present invention that are described in this specification are also intended to be understood as disclosed in all combinations with one another. In particular, the description of a feature that an embodiment comprises is—unless explicitly explained to the contrary—also not intended to be understood, in the present case, to mean that the feature is indispensable or essential for the function of the exemplary embodiment. The sequence of the method steps outlined in this specification in the individual flowcharts is not imperative, and alternative sequences of the method steps are conceivable—unless indicated otherwise. The method steps can be implemented in different ways, and implementation in software (by virtue of program instructions), hardware or a combination of the two is conceivable for implementing the method steps.

Terms used in the patent claims such as “comprise”, “have”, “include”, “contain” and the like do not exclude further elements or steps. The wording “at least in part” covers both the “in part” case and the “in full” case. The wording “and/or” is intended to be understood to mean that both the alternative and the combination are intended to be disclosed, that is to say that “A and/or B” means “(A) or (B) or (A and B)”. A plurality of units, persons or the like means multiple units, persons or the like within the context of this specification. The use of the indefinite article does not exclude a plurality. A single device can perform the functions of multiple units or devices cited in the patent claims. Reference signs indicated in the patent claims are not intended to be regarded as restrictions for the means and steps employed.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for a shipment storage apparatus, wherein the shipment storage apparatus comprises a storage space, and wherein the storage space has a plurality of shipment retainers arranged in it, the method comprising:
obtaining access authorization information, wherein the access authorization information authorises a user to access one or more of the shipment retainers,
determining whether access by the user to one or more of the shipment retainers can be granted, at least in part on the basis of the obtained access authorization information,
only if it has been determined that access by the user to one or more of the shipment retainers can be granted:
granting or causing the granting of access of the user to the storage space and
determining or causing the determining of whether the user accesses only the one or more of the shipment retainers that the access authorization information authorises the user to access.

2. The method according to claim 1, wherein the access authorization information is received from a portable user apparatus.

3. The method according to claim 1, wherein the access authorization information is one of the following pieces of access authorization information:
access authorization information for collecting of at least one shipment,
access authorization information for depositing of at least one shipment.

4. The method according to claim 1, wherein the shipment storage apparatus is a building and/or part of a building, and wherein the storage space is a room of the building.

5. The method according to claim 1, wherein the access for the user to the storage space is granted by unlocking and/or opening a door of the shipment storage apparatus.

6. The method according to claim 1, wherein the determining of whether the user accesses only one or more of the shipment retainers that the access authorization information authorises the user to access is based at least in part on sensor information.

7. The method according to claim 6, wherein the sensor information represents one or more parameters captured by one or more sensors arranged in the storage space and/or by one or more sensors of the shipment retainers.

8. The method according to claim 6, wherein each of the shipment retainers comprises at least one sensor, and wherein the respective sensor is configured to capture at least one of the following shipment retainer parameters:
a weight of a shipment retained by the respective shipment retainer,
a vibration in the respective shipment retainer,
opening and/or closing of a closure means of the respective shipment retainer,
damage to the respective shipment retainer and/or to a part of the shipment retainer,
a tag on a shipment retained by the respective shipment retainer.

9. The method according to claim 1, further comprising:
if it is determined that the user unauthorisedly accesses at least one shipment retainer of the shipment retainers that the access authorization information does not authorise the user to access, triggering and/or causing the triggering of a first alarm action.

10. The method according to claim 9, further comprising:
if it is determined that the user continues to unauthorisedly access the at least one shipment retainer of the shipment retainers after a predetermined period has elapsed after the triggering and/or causing of the triggering of the first alarm action, triggering and/or causing of the triggering of a second alarm action.

11. The method according to claim 10, wherein the second alarm action comprises notifying and/or causing the notification of one of more further users and/or logging and/or causing the logging of the unauthorised access.

12. The method according to claim 9, wherein the first alarm action is performed by a signal transmitter of the shipment storage apparatus, in particular an audible and/or visual signal transmitter.

13. A control apparatus for a shipment storage apparatus, wherein the shipment storage apparatus comprises a storage space, and wherein the storage space has a plurality of shipment retainers arranged in it, the control apparatus, comprising at least one processor and at least one memory having program instructions, wherein the at least one memory and the program instructions are configured, together with the at least one processor, to cause the control apparatus to perform:
obtaining access authorization information, wherein the access authorization information authorises a user to access one or more of the shipment retainers,
determining whether access by the user to one or more of the shipment retainers can be granted, at least in part on the basis of the obtained access authorization information,
only if it has been determined that access by the user to one or more of the shipment retainers can be granted:
granting or causing the granting of access of the user to the storage space and
determining or causing the determining of whether the user accesses only the one or more of the shipment retainers that the access authorization information authorises the user to access.

14. A system, comprising:
a shipment storage apparatus, wherein the shipment storage apparatus comprises a storage space, and wherein the storage space has a plurality of shipment retainers arranged in it, and
a control apparatus according to claim 13.

15. The control apparatus according to claim 13, wherein the access authorization information is received from a portable user apparatus.

16. The control apparatus according to claim 13, wherein the access authorization information is one of the following pieces of access authorization information:
access authorization information for collecting of at least one shipment,
access authorization information for depositing of at least one shipment.

17. The control apparatus according to claim 13, wherein the shipment storage apparatus is a building and/or part of a building, and wherein the storage space is a room of the building, and wherein the access for the user to the storage space is granted by unlocking and/or opening a door of the shipment storage apparatus.

18. The control apparatus according to claim 13, wherein the determining of whether the user accesses only one or more of the shipment retainers that the access authorization information authorises the user to access is based at least in part on sensor information.

19. The control apparatus according to claim 18, wherein the sensor information represents one or more parameters captured by one or more sensors arranged in the storage space and/or by one or more sensors of the shipment retainers.

20. The control apparatus according to claim 19, wherein each of the shipment retainers comprises at least one sensor, and wherein the respective sensor is configured to capture at least one of the following shipment retainer parameters:
a weight of a shipment retained by the respective shipment retainer,
a vibration in the respective shipment retainer,
opening and/or closing of a closure means of the respective shipment retainer,
damage to the respective shipment retainer and/or to a part of the shipment retainer,
a tag on a shipment retained by the respective shipment retainer.

21. The control apparatus according to claim 13, wherein the at least one memory and the program instructions are further configured, together with the at least one processor, to cause the control apparatus to perform at least one of:
if it is determined that the user unauthorisedly accesses at least one shipment retainer of the shipment retainers that the access authorization information does not authorize the user to access, triggering and/or causing the triggering of a first alarm action;
if it is determined that the user continues to unauthorisedly access the at least one shipment retainer of the shipment retainers after a predetermined period has elapsed after the triggering and/or causing of the triggering of the first alarm action, triggering and/or causing of the triggering of a second alarm action.
